(19) United States
(12) Patent Application Publication
(10) Pub. No.: US 2018/0197436 A1
(43) Pub. Date: Jul. 12, 2018

(54) Memorial Arrangement

(71) Applicant: Phillip Patrick Sweeney, Darawank (AU)

(72) Inventor: Phillip Patrick Sweeney, Darawank (AU)

(21) Appl. No.: 15/866,170

(22) Filed: Jan. 9, 2018

(30) Foreign Application Priority Data
Jan. 10, 2017 (AU) 2017900051

(51) Int. Cl. G09B 19/00; G09B 5/02

(52) U.S. Cl. CPC G09B 19/0046; G09B 5/02

(57) ABSTRACT

A memorial apparatus for perpetuating the memory of deceased armed forces personnel is disclosed and takes the form of a first area of land adjacent a road, and at least one amenities structure on the first area and accessible by vehicles from the road. Also provided are a multiplicity of small second land areas each of which is allocated to a nominated one of the deceased armed forces personnel, and each of which carries a marker either visible to an observer or detectable by a portable electronic device with GPS capability. The second land areas are located adjacent at least one side of the public road and form a road side steering or guiding arrangement to shepherd or urge persons towards the amenities structure. The amenities structure includes a publically accessible database containing data relating to (generally deceased) arms forces personnel.

### RELATED APPLICATIONS

This application claims benefit of priority of Australian Patent Application Serial No. 2017900051 filed Jan. 10, 2017, which is hereby incorporated by reference in its entirety.

### FIELD OF THE INVENTION

The present invention relates to memorials and, in particular, to memorials commemorating deceased armed forces personnel.

### BACKGROUND ART

Since ancient times humans have attempted to commemorate, or keep alive, their memories of their dead. Generally these attempts have involved the construction of memorials, usually of stone, and many fine and enduring structures have been created in this manner. For example, many countries have a tomb of the unknown soldier, war memorials in public plazas, and the like. Australia, Britain and the USA, in particular, have a strong cultural ethos in this connection. For example, in Australia returned servicemen's licensed clubs each evening at sunset call a halt to drinking, dining, entertaining and other activities, all patrons stand, and the Ode to Remembrance is recited.

However, not all memorials are constructed from stone and so memorials can take many and varied forms. U.S. Pat. No. 9,464,454 and US Patent Application Publication Nos. 2014/0136372 and 2016/0253771 exemplify such memorials. Other forms of memorials include groves of memorial trees or, in Australia, the Remembrance Driveway extending from Sydney to Canberra. At spaced apart intervals along this Remembrance Driveway are located vehicle accessible rest areas including various structural amenities such as seats, tables, toilets and the like. These rest areas are each dedicated to the memorial of a specific winner of the highest Australian decoration for valour, the Victoria Cross. The rest areas serve a dual purpose of not only commemorating the Victoria Cross recipients, but also providing road safety “driver reviver” roadside laybys which function to ameliorate driver fatigue. A similar arrangement is in place in the USA in relation to the Blue Star highway network.

### SUMMARY

The apparatuses described herein build upon this cultural foundation and provide a means of commemorating and/or perpetuating the memory of the very many ordinary men and women who have served their country in a military capacity.

In accordance with a first aspect, there is disclosed a memorial apparatus for perpetuating the memory of deceased armed forces personnel, said apparatus comprising:

a first area of land adjacent a road,

at least one amenities structure on said first area and accessible by vehicles from said road,

a multiplicity of small second land areas each of which is allocated to a nominated one of said deceased armed forces personnel, and each of which carries a marker either visible to an observer or detectable by a portable electronic device with GPS capability,

said second land areas being located adjacent at least one side of said public road and forming a road side steering or guiding means to shepherd persons towards said amenities structure, and

said amenities structure including a publically accessible database containing data relating to deceased arms forces personnel.

In accordance with a second aspect there is disclosed a method of perpetuating the memory of deceased armed forces personnel, said method comprising the steps of: making accessible to vehicles from a road at least one amenities structure on a first area of land adjacent said road,

providing said amenities structure with a publicly accessible database containing data related to deceased armed forces personnel,
providing a multiplicity of small land areas located adjacent at least one side of said road, said small land areas having a configuration forming a roadside steering or guiding arrangement to shepherd or urge persons towards the amenities structure, allocating each of said small second land areas to a nominated one of said deceased armed forces personnel, and
providing each of said small second land areas with a marker either visible to an observer or detectable by a portable electronic device with GPS capability.

### BRIEF DESCRIPTION OF THE DRAWINGS

A preferred embodiment of the invention will now be described, by way of example only, with reference to the accompanying drawings in which:

FIG. 1 is a schematic perspective view of a memorial apparatus of a first embodiment,

FIG. 2 is a front elevation of the amenities structure of the memorial apparatus of FIG. 1,

FIG. 3 is a schematic representation of a handheld electronic communication device with GPS capability in response mode, and

FIG. 4 is a plan view of one of the second land areas.

### DETAILED DESCRIPTION OF THE PREFERRED EMBODIMENTS

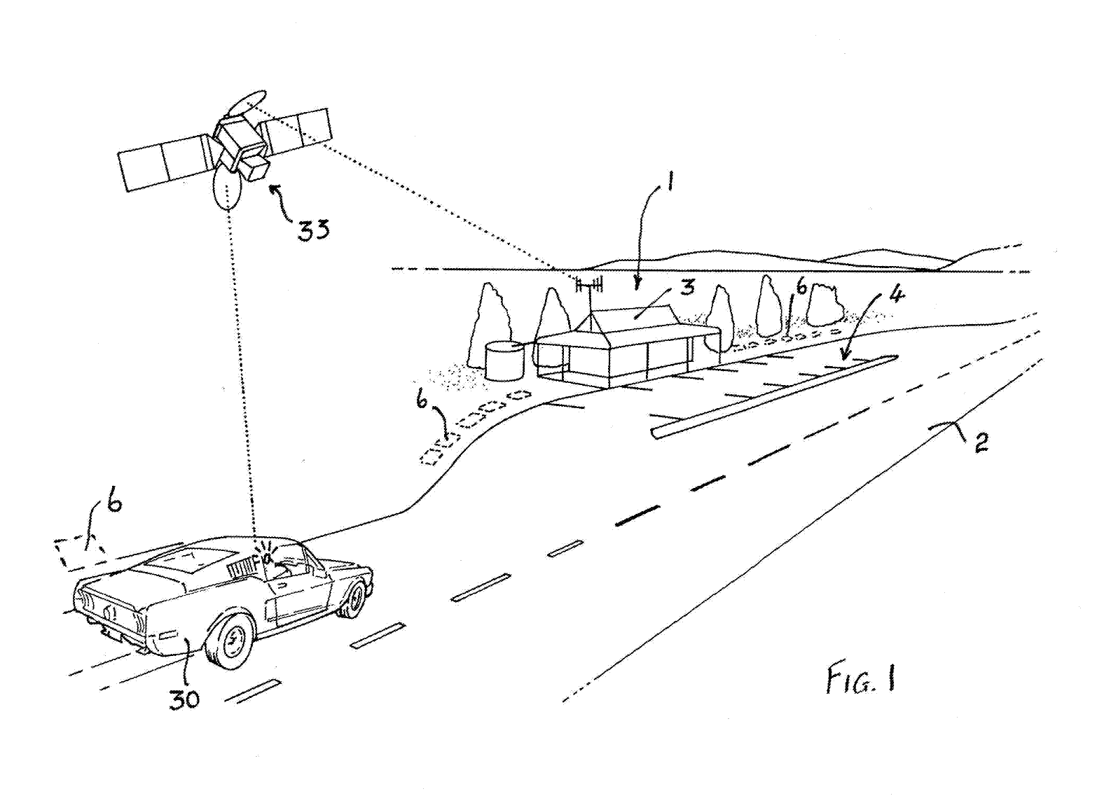

As seen in FIG. 1, a memorial rest area 1 lies alongside a c road 2 (which is typically a public road, but need not be) and includes an amenities building 3 and a number of designated car spaces 4. The rectangular area of land occupied by the amenities building 3 constitutes a first land area and is adjacent the road 2. To either side of the amenities building 3 and extending alongside the road 2 is a sequence of second land areas 6. Preferably the second land areas 6 are not physically marked on the ground but instead exist only as a boundary of a delineated area on a digitised map (not illustrated but conventional). That is, the second land areas 6 may be regarded as virtual areas and for this reason are designated in broken lines in FIG. 1. Furthermore, in order not to overburden the drawing, the number of second land areas 6 illustrated in FIG. 1 is very much less than the actual number as will become apparent hereafter.

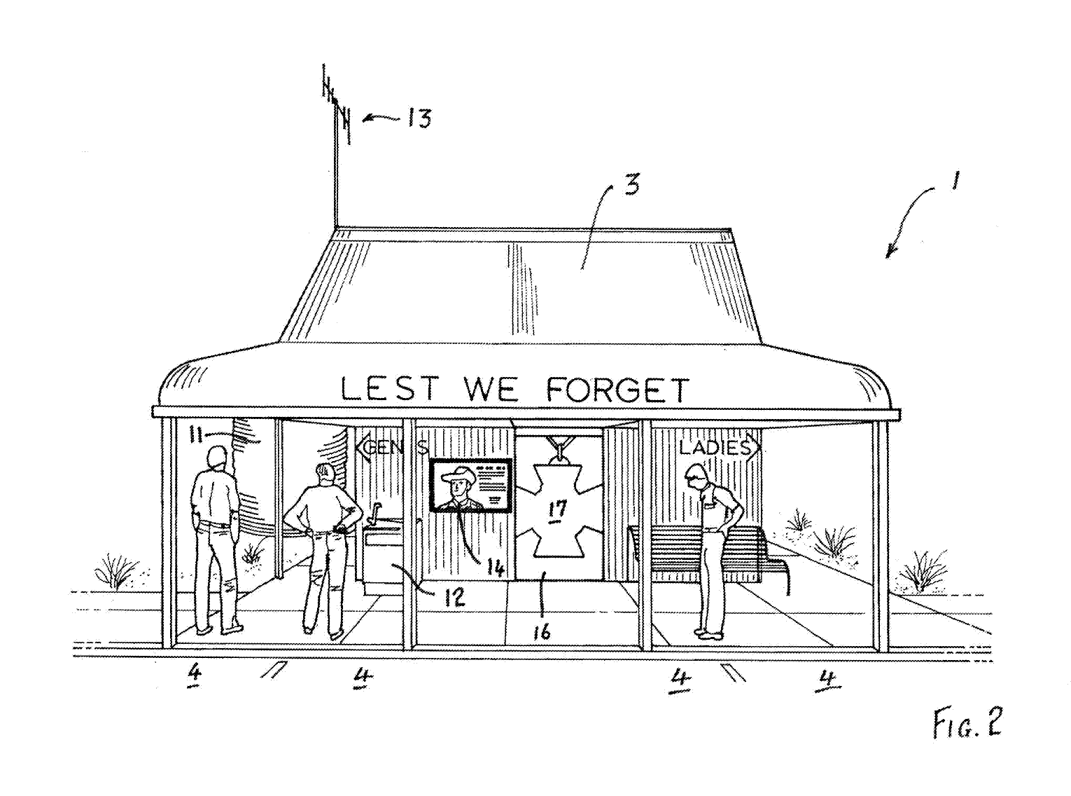

Turning now to FIG. 2, the amenities building 3 provides public amenities including GENTS and LADIES toilets, a water supply tank 11, a drinking fountain 12, a communications antenna 13, and a digital display screen 14. Preferably the memorial rest area 1 is dedicated to the memory of a specific recipient of an award for valor (such as the Medal of Honor in the USA and the Victoria Cross in Australia and Britain) and the glass front door 16 of the amenities building 3 is provided with a frosted outline 17 of the corresponding medal. Not illustrated in FIG. 2 but located within the amenities building 3 is a public notice board which includes information about the recipient of the award for valor, the circumstances of the incident leading to the award of the decoration, about the career of the recipient, and the like.

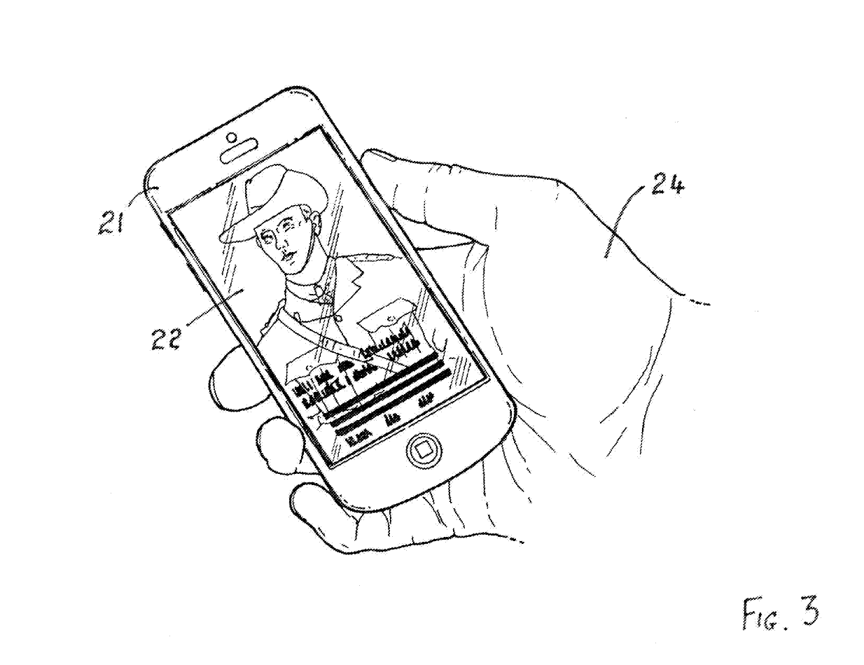

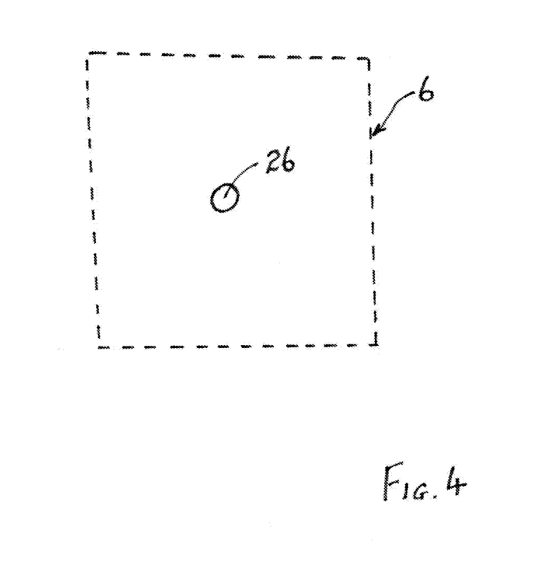

As seen in FIG. 3, a hand-held device 21 has a screen 22 and is held in the hand of a subscriber or sponsor 24. As seen in FIG. 4, each of the second land areas 6 is rectangular, and preferably square, having dimensions of approximately 1 m×1 m. Located at the centre of each of the second land areas 6 is a marker 26 which can be either a physical marker such as a concrete disk embedded into the ground, or a virtual marker apparent only on a digital representation of the second land area 6. In both cases the marker 26 has coordinates of latitude and longitude which are unique to the specific second land area 6.

It will be apparent that the number of Medal of Honor winners is very much less than the number of individual military personnel which took part in any given military conflict. Therefore it is feasible to allocate individual memorial rest areas 1 to specific individual Medal of Honor winners. However, each of the second land areas 6 can be allocated to a corresponding one of the very many individual military personnel, in general now deceased, and whose memory it is intended should be commemorated.

A perennial problem for the responsible authority burdened with the construction and upkeep of memorials such as memorial rest area 1, is to be able to have a source of funds sufficient for the necessary construction and upkeep. One way of providing such a source of funds is to offer the second land areas 6 to individual subscribers or sponsors 24 who provide an annual subscription fee and in return are allocated a specific one of the second land areas 6.

Preferably, there is no particular personal connection (such as a parent or grandparent or uncle etc.) between the individual subscribers or sponsors 24 and the military person of their corresponding allocated second land areas 6. As a consequence, a subscriber or sponsor 24 can be driving along the public road 2 in a motor vehicle 30 and passes by their particular allocated second land area 6. (FIG. 1 illustrates the situation in a left-hand drive country such as Australia or Britain. In a right-hand drive country such as the USA the vehicle 30 would be travelling in the opposite direction.) As a result, the hand-held device 21 with GPS capability communicates with one or more satellites 33 and as the vehicle 30 approaches the allocated second land area 6 causes the hand-held device 21 to be activated as schematically illustrated in FIG. 3.

As a consequence of this activation, a subscriber or sponsor 24 is able to download information pertaining to the deceased military person corresponding to the subscriber or sponsor 24. Such information can include personal details such as a name, a photograph, a short biography, etc. In this way, the interest of the subscriber or sponsor 24 in the sacrifice made by military service men and women is stimulated and the memory of the deceased military person is burnished. In addition, the subscriber or sponsor 24 is induced towards, or shepherded towards, the memorial rest area 1 having had their interest in military service men and women stimulated.

Preferably be hand-held electronic device 21 utilises NFC (near frequency communication) for the purpose of registering or displaying on the digital noticeboard or display screen 14 in the amenities building 3 the “pilgrimage achievement” of the subscriber or sponsors 24.

The foregoing describes only one embodiment of the present invention and modifications, obvious to those skilled in the electronic arts, can be made thereto without departing from the scope of the present invention.

The term “comprising” (and its grammatical variations) as used herein is used in the inclusive sense of “including” or “having” and not in the exclusive sense of “consisting only of”.

LEST WE FORGET

1. A memorial apparatus for perpetuating the memory of deceased armed forces personnel, said apparatus comprising:
a first area of land adjacent a road,
at least one amenities structure on said first area and accessible by vehicles from said road,
a multiplicity of small second land areas each of which is allocated to a nominated one of said deceased armed forces personnel, and each of which carries a marker either visible to an observer or detectable by a portable electronic device with GPS capability,
said second land areas being located adjacent at least one side of said public road and forming a road side steering or guiding arrangement to shepherd or urge persons towards said amenities structure, and
said amenities structure including a publically accessible database containing data relating to deceased armed forces personnel.

2. The apparatus as claimed in claim 1 wherein said marker is located approximately at the centre of the corresponding second land area.

3. The apparatus as claimed in claim 2 wherein the boundaries of said second land areas are not physically represented.

4. The apparatus as claimed in claim 3 wherein the boundaries of said second land areas are virtual and are represented only in or by electronic equipment.

5. The apparatus as claimed in claim 1 wherein said second land areas are substantially rectangular and have sides each having a length of the order of one metre.

6. The apparatus as claimed in claim 1 wherein said second land areas are each allocated to both a corresponding deceased armed forces person and to a corresponding subscriber or sponsor.

7. The apparatus as claimed in claim 6 wherein said portable electronic device with GPS capability associated with one of subscribers responds when in close proximity to the second land area allocated to said one subscriber.

8. The apparatus as claimed in claim 7 wherein the range of said close proximity permits said responding device to respond when located in a motor vehicle driving on a public road past the second land area allocated to said one subscriber.

9. The apparatus as claimed in claim 6 wherein said portable electronic device with GPS capability associated with said one subscriber or sponsor, enables said one subscriber or sponsor to access the military history of said corresponding deceased armed services person.

10. The apparatus as claimed in claim 1 wherein said publicly accessible database at said amenities structure is able to access the military history of each corresponding deceased armed services person of the second land areas adjacent said amenities structure.

11. A method of perpetuating the memory of deceased armed forces personnel, said method comprising the steps of:
making accessible to vehicles from a road at least one amenities structure on a first area of land adjacent said road,
providing said amenities structure with a publicly accessible database containing data related to deceased armed forces personnel,
providing a multiplicity of small land areas located adjacent at least one side of said road, said small land areas having a configuration forming a roadside steering or guiding arrangement to shepherd or urge persons towards the amenities structure,
allocating each of said small second land areas to a nominated one of said deceased armed forces personnel, and
providing each of said small second land areas with a marker either visible to an observer or detectable by a portable electronic device with GPS capability.

12. The method as claimed in claim 11 including the further step of locating said marker approximately at the centre of the corresponding second land area.

13. The method as claimed in claim 12 wherein the boundaries of said second land areas are not physically represented.

14. The method as claimed in claim 13 wherein the boundaries of said second land areas are virtual and are represented only in or by electronic equipment.

15. The method as claimed in claim 11 including the further step of forming said second land areas to be substantially rectangular and having sides each having a length of the order of one metre.

16. The method as claimed in claim 11 comprising the further step of allocating said second land areas to both a corresponding deceased armed forces person and to a corresponding subscriber or sponsor.

17. The method as claimed in claim 16 wherein said portable electronic device with GPS capability associated with one of subscribers or sponsors responds when in close proximity to the second land area allocated to said one subscriber or sponsor.

18. The method as claimed in claim 17 wherein the range of said close proximity permits said responding device to respond when located in a motor vehicle driving on a public road past the second land area allocated to said one subscriber or sponsor.

19. The method as claimed in claim 6 wherein said portable electronic device with GPS capability associated with said one subscriber or sponsor, enables said one subscriber or sponsor to access the military history of said corresponding deceased armed services person.

20. The method as claimed in claim 11 wherein said publicly accessible database at said amenities structure is able to access the military history of each corresponding deceased armed services person of the second land areas adjacent said amenities structure.
